(19) United States
(12) Patent Application Publication
(10) Pub. No.: US 2025/0102672 A1
(43) Pub. Date: Mar. 27, 2025

(54) Apparatus For Recognizing Object And Method Thereof

(71) Applicants: Hyundai Motor Company, Seoul (KR); Kia Corporation, Seoul (KR)

(72) Inventor: En Sun Lee, Seoul (KR)

(21) Appl. No.: 18/616,725

(22) Filed: Mar. 26, 2024

(30) Foreign Application Priority Data
Sep. 25, 2023 (KR) 10-2023-0128421

(51) Int. Cl. G01S 17/89; G01S 7/48; G06F 18/22

(52) U.S. Cl. CPC G01S 17/89; G01S 7/4808; G06V 10/74

(57) ABSTRACT

The present disclosure relates to an object recognition apparatus and method, and the object recognition apparatus. The apparatus may comprise a sensor and a processor, wherein the processor is configured to identify, based on sensing information of the sensor, an object box comprising a plurality of contour points representing an object, determine a plurality of minimum values, wherein each of the plurality of minimum values is a minimum value among distances between one of the plurality of contour points and line segments constituting a boundary of the object box, determine a degree of mismatch between the object box and the plurality of contour points based on at least one of the plurality of minimum values or a number of the plurality of contour points, and output, based on the degree of mismatch, a signal indicating whether the object is a stationary object.

### CROSS-REFERENCE TO RELATED APPLICATION

This application claims the benefit of priority to Korean Patent Application No. 10-2023-0128421, filed in the Korean Intellectual Property Office on Sep. 25, 2023, the entire contents of which are incorporated herein by reference.

### TECHNICAL FIELD

The present disclosure relates to an object recognition apparatus and method, and more particularly, to a technique for identifying characteristics of an object based on the distribution of contour points obtained through a sensor (e.g., light detection and ranging (LIDAR) sensor).

### BACKGROUND

An autonomous vehicle or vehicle with activated driver assistance devices may figure out surrounding environments through a sensor (e.g., LiDAR) and collect data for driving.

A vehicle may obtain data indicating the position of an object around the vehicle through a LIDAR. A distance from a LIDAR to an object may be obtained through an interval between the time if laser is transmitted by the LIDAR and the time if the laser reflected by the object is received. A vehicle may identify the location of a point included outside of the object in a space where the vehicle is located, based on the angle of the transmitted laser and the distance to the object.

Based on the movement information of acquired points, the autonomous vehicle or the vehicle with an activated driver assistance device may identify the information of an object represented by the points. In particular, technology to identify whether an object is a moving object, an object capable of being in a moving state, or an object incapable of being in a moving state may be used to ensure the stability of autonomous driving or driver assistance driving and reduce the risk of accidents.

### SUMMARY

According to the present disclosure, an apparatus may comprise a sensor and a processor, wherein the processor is configured to identify, based on sensing information of the sensor, an object box comprising a plurality of contour points representing an object, determine a plurality of minimum values, wherein each of the plurality of minimum values is a minimum value among distances between one of the plurality of contour points and line segments constituting a boundary of the object box, determine a degree of mismatch between the object box and the plurality of contour points based on at least one of the plurality of minimum values or a number of the plurality of contour points, and output, based on the degree of mismatch, a signal indicating whether the object is a stationary object.

The apparatus, wherein the processor is configured to determine a sum of distances between an N-th contour point and the line segments based on a minimum value among distances between the N-th contour point and the line segments, wherein the N-th contour point is among a first contour point to M-th contour point representing the object, and wherein N is a natural number satisfying 1≤N≤M and M is a natural number of 2 or greater, determine a second sum of distances between an (N+1)-th contour point and the line segments based on the sum of distances and a minimum value among distances between the (N+1)-th contour point and the line segments, wherein the (N+1)-th contour point is next to the N-th contour point, and determine, based on a sum of distances between an M-th contour point and the line segments, the degree of mismatch.

The apparatus, wherein the processor is configured to determine a minimum value among distances between an N-th contour point and the line segments, wherein N is a natural number satisfying 1≤N≤M and the N-th contour points are among a first contour point to M-th contour point representing the object, wherein M is a natural number of 2 or greater, and determine the degree of mismatch based on a sum of the plurality of minimum values, wherein each of the plurality of minimum values is a minimum value among distances between a respective contour point among the first contour point to the M-th contour point of the plurality of contour points and the line segments.

The apparatus, wherein the processor is configured to determine a sum of distances associated with an N-th layer based on a sum of minimum values among distances between contour points included in the N-th layer and the line segments, wherein N is a natural number satisfying 1≤N≤M and the N-th layer is among first to M-th layers included in the object box, and wherein M is a natural number greater than or equal to 2, determine a sum of distances associated with an (N+1)-th layer based on the sum of distances associated with the N-th layer and a sum of minimum values among distances between contour points included in the (N+1)-th layer and the line segments, wherein the (N+1)-th layer is next to the N-th layer, and determine the degree of mismatch based on a sum of distances associated with the M-th layer and a number of the plurality of contour points representing the object.

The apparatus, wherein the processor is configured to determine a sum of distances associated with an N-th layer based on a sum of a set of minimum values, wherein each of the set of minimum values is a minimum value among distances between one of contour points included in the N-th layer and the line segments, wherein N is a natural number satisfying 1≤N≤M and the N-th layer is among a first layer to M-th layer included in the object box, and wherein M is a natural number greater than or equal to 2, and determine the degree of mismatch based on a value obtained by summing up distances associated with the first layer to the M-th layer and a number of the plurality of contour points representing the object.

The apparatus, wherein the processor is configured to determine a distance between one contour point of the plurality of contour points and one line segment of the line segments based on coordinates of the one contour point and coordinates of two points passing through the one line segment.

The apparatus, wherein the processor is configured to determine the degree of mismatch based on a value obtained by dividing a sum of the plurality of minimum values by a number of contour points representing the object.

The apparatus, wherein the object box may comprise three or more line segments. The apparatus, wherein the processor is configured to assign a reliability value for indicating whether the object is a stationary object based on determining that the degree of mismatch is greater than a threshold degree of mismatch and determine, based on the reliability value, whether the object is the stationary object.

The apparatus, wherein the processor is configured to determine a first reliability value for indicating whether the object is a stationary object based on determining a first degree of mismatch as the degree of mismatch, determine a second reliability value greater than the first reliability value based on determining a second degree of mismatch greater than the first degree of mismatch as the degree of mismatch, and determine whether the object is a stationary object based on the first reliability value or the second reliability value.

The apparatus, wherein the processor is configured to identify the object box as being a specified shape and determine, based on the degree of mismatch, whether the object is an object corresponding to the specified shape.

The apparatus, wherein the processor is configured to assign, to the object, an identifier indicating that the object is a stationary object, based on a determination that the object is a stationary object.

The apparatus, wherein the processor is configured to determine, based on the degree of mismatch, a reliability value indicating whether the object is a stationary object and determine whether the object is a stationary based on a value obtained by multiplying the reliability value by a weight.

According to the present disclosure, a method may comprise identifying, based on sensing information of the sensor, an object box comprising a plurality of contour points representing an object; determining a plurality of minimum values, wherein each of the plurality of minimum values is a minimum value among distances between one of the plurality of contour points and line segments constituting a boundary of the object box; determining a degree of mismatch between the object box and the plurality of contour points based on at least one of: the plurality of minimum values, or a number of the plurality of contour points; and outputting, based on the degree of mismatch, a signal indicating whether the object is a stationary object.

The method, wherein the determining the degree of mismatch may comprise: determining a sum of distances between an N-th contour point and the line segments based on a minimum value among distances between the N-th contour point and the line segments, wherein N is a natural number satisfying 1≤N≤M and the N-th contour point is among a first contour point to M-th contour point representing the object, and wherein M is a natural number of 2 or greater; determining a second sum of distances between an (N+1)-th contour point and the line segments based on the sum of distances and a minimum value among distances between the (N+1)-th contour point and the line segments, wherein the (N+1)-th contour point is next to the N-th contour point; and determining, based on a sum of distances between an M-th contour point and the line segments, the degree of mismatch.

The method, wherein the determining the degree of mismatch may comprise: determining a minimum value among distances between an N-th contour point and the line segments, wherein N is a natural number satisfying 1≤N≤M and the N-th contour point is among a first contour point to M-th contour point representing the object, wherein M is a natural number of 2 or greater; and determining the degree of mismatch based on a sum of the plurality of minimum values, wherein each of the plurality of minimum values is a minimum value among distances between a respective contour point among the first contour point to the M-th contour point of the plurality of contour points and the line segments.

The method, wherein the determining the degree of mismatch may comprise: determining a sum of distances associated with an N-th layer based on a sum of a set of minimum values, wherein each of the set of minimum values is a minimum value among distances between one of contour points included in the N-th layer and the line segments, wherein N is a natural number satisfying 1≤N≤M and the N-th layer is among a first layer to M-th layer included in the object box, and wherein where M is a natural number greater than or equal to 2; determining a sum of distances associated with an (N+1)-th layer based on the sum of distances associated the N-th layer and a sum of a second set of minimum values, wherein each of the second set of minimum values is a minimum value among distances between one of contour points included in the (N+1)-th layer and the line segments, wherein the (N+1)-th layer is next to the N-th layer; and determining the degree of mismatch based on a sum of distances associated with the M-th layer and a number of the plurality of contour points representing the object.

The method, wherein the determining the degree of mismatch may comprise: determining a sum of distances associated with an N-th layer based on a sum of a set of minimum values, wherein each of the set of minimum values is a minimum value among distances between one of contour points included in the N-th layer and the line segments, wherein N is a natural number satisfying 1≤N≤M and the N-th layer is among a first layer to M-th layer included in the object box, wherein M is a natural number greater than or equal to 2; and determining the degree of mismatch based on a value obtained by summing up distances associated with the first layer to the M-th layer and a number of the plurality of contour points representing the object.

The method, wherein the determining the plurality of minimum values may comprise determining a distance between one contour point of the plurality of contour points and one line segment of the line segments based on coordinates of the one contour point and coordinates of two points passing through the one line segment.

The method, wherein the determining the degree of mismatch may comprise determining the degree of mismatch based on a value obtained by dividing a sum of the plurality of minimum values by a number of contour points representing the object.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of an object recognition apparatus according to an example of the present disclosure;

FIG. 2 shows an example of information required to classify objects in an object recognition apparatus or an object recognition method according to an example of the present disclosure;

FIG. 3 shows an example of an area in which the weights of reliability values vary according to information related to an object recognition apparatus or an object recognition method according to an example of the present disclosure;

FIG. 4 shows an example of a flowchart of operation of an object recognition apparatus for identifying whether an object is an object incapable of being in a moving state by identifying a contour-box distance in an object recognition apparatus or an object recognition method according to an example of the present disclosure;

FIG. 5 shows an example of the distribution of contour points in an object recognition apparatus or an object recognition method according to an example of the present disclosure;

FIG. 6 shows an example of the distribution of contour points included in an individual layer for identifying a degree of match in an object recognition apparatus or an object recognition method according to an example of the present disclosure;

FIG. 7 shows an example of a contour-box distance corresponding to a contour point in an object recognition apparatus or an object recognition method according to an example of the present disclosure;

FIG. 8 shows an example of a flowchart of operation of an object recognition apparatus for identifying whether an object is an object incapable of being in a moving state according to a degree of mismatch in an object recognition apparatus or an object recognition method according to an example of the present disclosure;

FIG. 9 shows an example of the distribution of contour points representing an object incapable of being in a moving state in an object recognition apparatus or an object recognition method according to an example of the present disclosure;

FIG. 10 shows an example of the distribution of contour points representing an object incapable of being in a moving state in an object recognition apparatus or an object recognition method according to an example of the present disclosure;

FIG. 11 shows an example of the distribution of contour points representing an object incapable of being in a moving state in an object recognition apparatus or an object recognition method according to an example of the present disclosure;

FIG. 12 shows an example of the distribution of contour points representing an object incapable of being in a moving state in an object recognition apparatus or an object recognition method according to an example of the present disclosure; and

FIG. 13 shows an example of a computing system related to an object recognition apparatus or an object recognition method according to an example of the present disclosure.

### DETAILED DESCRIPTION

Hereinafter, some examples of the present disclosure will be described in detail with reference to the example drawings. In adding the reference numerals to the components of each drawing, it should be noted that the identical or equivalent component is designated by the identical numeral even if they are displayed on other drawings. Further, in describing the example of the present disclosure, a detailed description of well-known features or functions will be ruled out in order not to unnecessarily obscure the gist of the present disclosure.

In describing the components of the example according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Further, the terms “unit”, “device”, “member”, “body”, or the like used hereinafter may indicate at least one shape structure or may indicate a unit for processing a function.

In addition, in examples of the present disclosure, the expressions “greater than” or “less than” may be used to indicate whether a specific condition is satisfied or fulfilled, but are used only to indicate examples, and do not exclude “greater than or equal to” or “less than or equal to”. A condition indicating “greater than or equal to” may be replaced with “greater than”, a condition indicating “less than or equal to” may be replaced with “less than”, a condition indicating “greater than or equal to and less than” may be replaced with “greater than and less than or equal to”. In addition, ‘A’ to ‘B’ means at least one of elements from A (including A) to B (including B).

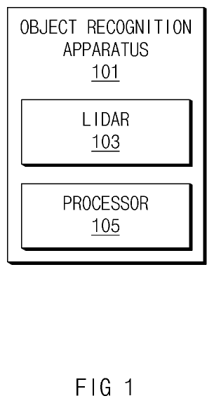

Hereinafter, examples of the present disclosure will be described in detail with reference to FIGS. 1 to 13.

FIG. 1 shows an example of an object recognition apparatus according to an example of the present disclosure.

Referring to FIG. 1, an object recognition apparatus 101 according to an example of the present disclosure may be implemented inside a vehicle. In this case, the object recognition apparatus 101 may be integrally formed with internal control units of the vehicle, or may be implemented as a separate device and connected to the control units of the vehicle by separate connection means.

Referring to FIG. 1, the object recognition apparatus 101 may include a sensor (e.g., a LIDAR 103) and a processor 105.

According to an example, the processor 105 of the object recognition apparatus 101 may acquire a point cloud representing the object through the LIDAR 103. The processor 105 of the object recognition apparatus 101 may identify contour points among points included in the point cloud.

According to an example, the contour points may be acquired by a LiDAR. For example, the contour points may be identified in each of layers formed on the z-axis, among the x-axis, y-axis, and z-axis. For example, the contour points may be obtained based on representative points included in a point cloud in each of the layers formed on the z-axis among the x-axis, y-axis, and z-axis. For example, the representative points may include all or part of points located outside among a plurality of points included in the point cloud. For example, a point cloud may be obtained by performing clustering based on each of a plurality of points acquired by a LIDAR being identified within a specified distance.

According to an example, an object box may include a virtual box to which information related to an external object (e.g., a vehicle, a person, a tree, a tire, a road sign, etc.) is assigned. For example, the object box may be referred to as a contour box. According to an example, the contour box may be created (or formed) based on contour points. For example, the contour box may correspond to an external object. For example, the contour box may include the virtual box to which the information related to the external object is assigned. For example, the information related to the external object may include at least one of the type of the external object, the speed of the external object, the moving direction of the external object, or the position of the external object, or any combination thereof.

According to an example, the processor 105 of the object recognition apparatus 101 may identify an object box including contour points which are obtained through the LIDAR 103 and represent an object. The processor 105 of the object recognition apparatus 101 may identify a degree of mismatch that indicates a degree to which the distribution of contour points and the object box mismatch each other.

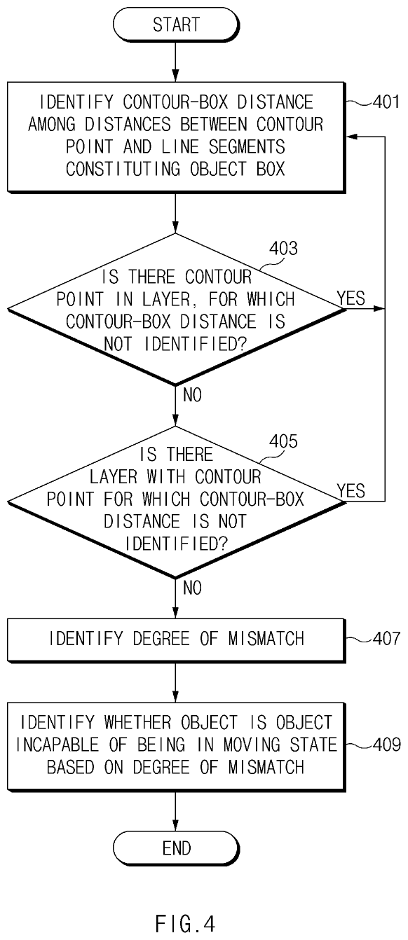

According to an example, the processor 105 of the object recognition apparatus 101 may identify a contour-box distance, which is the minimum value among distances between the contour point and line segments constituting the object box to identify the degree of mismatch. The operation of the object recognition apparatus in which the processor of the object recognition apparatus identifies the degree of mismatch based on the contour-box distances will be described with reference to FIGS. 4 to 8 below.

According to an example, the processor 105 of the object recognition apparatus 101 may identify a reliability value according to box matching information based on a degree of mismatch. The operation of the object recognition apparatus, which identifies a reliability value according to box matching information based on the degree of mismatch will be described below with reference to FIG. 4.

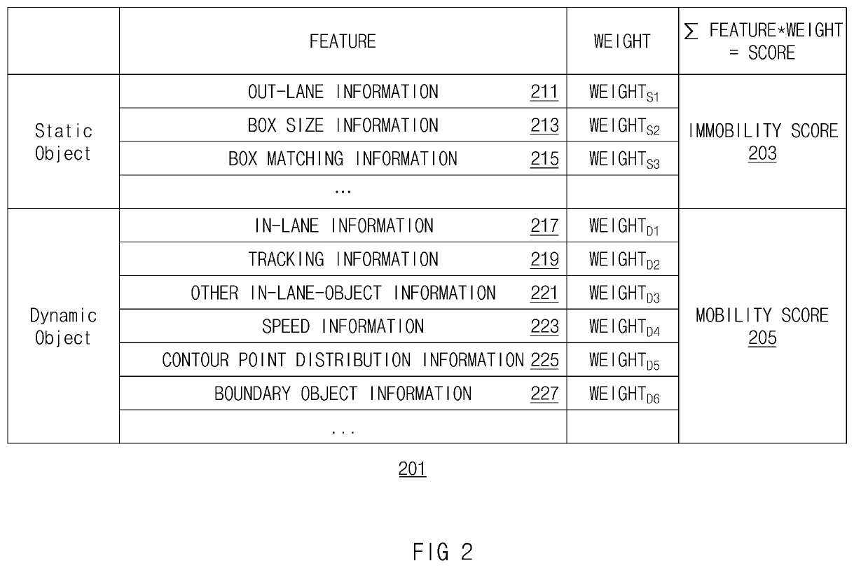

According to an example, the processor 105 of the object recognition apparatus 101 may calculate a score value representing a probability that an object is an object incapable of being in a moving state (e.g., a bridge pillar, a guardrail) based on a reliability value according to the box matching information of the object. The identifying of a score value indicating a probability that an object is an object incapable of being in a moving state (e.g., a stationary object, an immovable object, a fixed object, an object unable to move, a non-moving object, an object that is stuck, an object that is motionless, a static object, an object anchored in place, or a rigid object, etc.) based on the reliability value according to the box matching information will be described below with reference to FIG. 2.

According to an example, the processor 105 of the object recognition apparatus 101 may identify that an object is an object incapable of being in a moving state, based on a score value indicating the probability that an object is a moving object (e.g., a moving vehicle) or an object capable of being in a moving state (e.g., a stationary vehicle) being less than a score value indicating the probability that an object is an object incapable of being in a moving state (e.g., a road sign, a guard rail, a tree, etc.).

According to an example, the processor 105 of the object recognition apparatus 101 may assign, to the object, an identifier indicating that the object is an object incapable of being in a moving state, based on identifying that the object is an object incapable of being in a moving state. The identifier may be referred to as a flag, but may not be limited thereto.

FIG. 2 shows an example of information required to classify objects in an object recognition apparatus or an object recognition method according to an example of the present disclosure.

Referring to FIG. 2, table 201 may represent types of information for calculating a score for identifying whether an object is an object incapable of being in a moving state. An immobility score 203 may represent a score for identifying whether an object is an object that is unable to be in a moving state (e.g., a stationary object, an immovable object, a fixed object, an object unable to move, a non-moving object, an object that is stuck, an object that is motionless, a static object, an object anchored in place, or a rigid object, etc.). The immobility score 203 may be identified based on information such as out-lane information 211, box size information 213, and box matching information 215. A mobility score 205 may represent a score for identifying whether an object is a moving object or an object that is able to be in a moving state. The mobility score 205 may be identified based on information such as in-lane information 217, tracking information 219, other in-lane-object information 221, speed information 223, contour point distribution information 225, and boundary object information 227.

According to an example, a first reliability may be reliability for determining whether an object is an object incapable of being in a moving state. The processor of the object recognition apparatus may identify the immobility score 203 by the sum of values obtained by multiplying first reliabilities indicated by pieces of information by a weight. A second reliability may be reliability for determining whether an object is a moving object or an object capable of being in a moving state. The processor of the object recognition apparatus may identify the mobility score 205 by the sum of values obtained by multiplying second reliabilities indicated by pieces of information by a weight.

According to an example, the out-lane information 211 for identifying the immobility score 203 may represent a first reliability assigned based on whether an object is identified outside a lane. The box size information 213 for identifying the immobility score 203 may represent a first reliability assigned based on whether the size of an object box is greater than or equal to a reference size. The box matching information 215 for identifying the immobility score 203 may represent a first reliability assigned based on the distribution of contour points and the degree of match of the object box.

According to an example, the in-lane information 217 may represent a second reliability assigned based on whether an object is identified inside a lane. The tracking information 219 may represent a second reliability assigned based on whether an object is moving. The speed information 223 may represent a second reliability assigned based on the speed of an object. The boundary object information 227 may represent a second reliability assigned based on whether an object is viewed without being obscured at the boundary of a field of view.

According to an example, the immobility score 203 may be identified by the sum of values obtained by multiplying the first reliabilities represented by pieces of information by a weight. For example, the immobility score 203 may be identified by the sum of a value obtained by multiplying the first reliability according to the out-lane information 211 by a weight (e.g., weight_{S1}) corresponding to the out-lane information 211, a value obtained by multiplying the first reliability according to the box size information 213 by a weight (e.g., weight_{S2}) corresponding to the box size information 213, a value obtained by multiplying the first reliability according to the box matching information 215 by a weight (e.g., weight_{S3}) corresponding to the box matching information 215, or at least one of any combination thereof. However, examples of the present disclosure may not be limited thereto. According to an example, the immobility score 203 may be identified by adding up not only a value obtained by multiplying information listed in the table 201 by a weight, but also a value obtained by multiplying information not listed in the table 201 by the weight.

According to an example, the mobility score 205 may be identified by the sum of values obtained by multiplying the second reliabilities represented by pieces of information by a weight. For example, the mobility score 205 may be identified by the sum of at least one of a value obtained by multiplying the second reliability according to the in-lane information 217 by a weight (e.g., weight_{D1}) corresponding to the in-lane information 217, a value obtained by multiplying the second reliability according to the tracking information 219 by a weight (e.g., weight_{D2}) corresponding to the tracking information 219, a value obtained by multiplying the second reliability according to the other in-lane-object information 221 by a weight (e.g., weight_{D3}) corresponding to the other in-lane-object information 221, a value obtained by multiplying the second reliability according to the speed information 223 by a weight (e.g., weight_{D4}) corresponding to the speed information 223, a value obtained by multiplying the second reliability according to the contour point distribution information 225 by a weight (e.g., weight_{D5}) corresponding to the contour point distribution information 225, a value obtained by multiplying the second reliability according to the boundary object information 227 by a weight (e.g., weight_{D6}) corresponding to the boundary object information 227, or any combination thereof. However, examples of the present disclosure may not be limited thereto. According to an example, the mobility score 205 may be identified by adding up not only a value obtained by multiplying information listed in the table 201 by a weight, but also a value obtained by multiplying information not listed in the table 201 by the weight.

According to an example, if the mobility score 205 for a certain object is higher than the immobility score 203 for the certain object, the processor of the object recognition apparatus may identify that the certain object is a moving object or an object that is able to be in a moving state. According to an example, if the immobility score 203 for a certain object is higher than the mobility score 205 for the certain object, the processor of the object recognition apparatus may identify that the certain object is an object (e.g., a road sign, a wall, a power line, etc.) that is unable to be in a moving state.

According to an example of the present disclosure, the processor of the object recognition apparatus may identify a first reliability indicated by the box matching information 215. A method for identifying the first reliability represented by the box matching information 215 according to an example will be described below with reference to FIGS. 4 to 8. Hereinafter, a value of the first reliability represented by the box matching information 215 may be referred to as a reliability value.

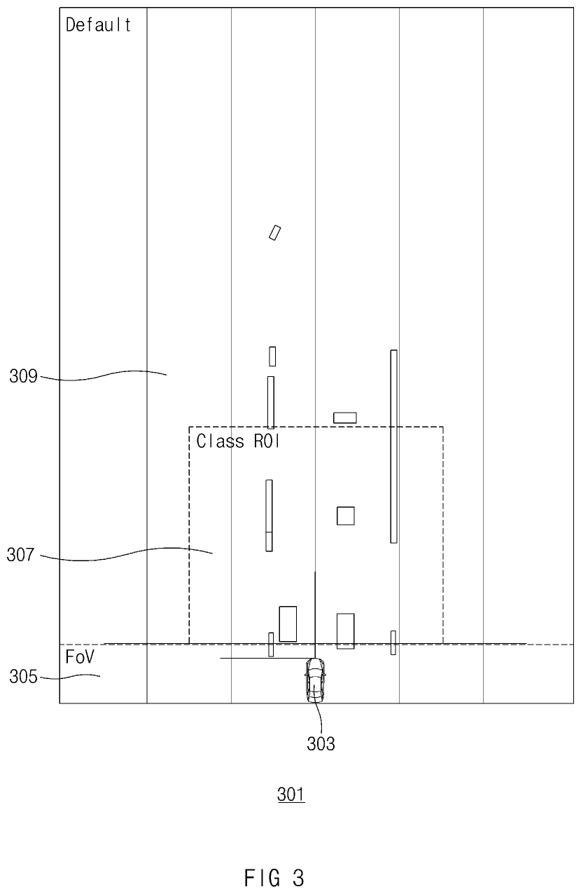

FIG. 3 shows an example of an area in which the weights of reliability values vary according to information related to an object recognition apparatus or an object recognition method according to an example of the present disclosure.

Referring to FIG. 3, a frame 301 may represent a first area 305, a second area 307, and a third area 309 separated according to a distance from a host vehicle 303 including the object recognition apparatus. The first area 305 may include an area within a field of view. The second area 307 (e.g., an area ahead of the host vehicle 303 but not within the field of view) may include an area for classifying objects of interest. The third area 309 (e.g., an area ahead of the host vehicle 303 and further away from the second area 307) may include areas other than the first area 305 and the second area 307.

According to an example, the first area 305 may be referred to as a field of view (FoV) area, but may not be limited thereto. The second area 307 may be referred to as a class region of interest (class ROI), but may not be limited thereto. The third area 309 may be referred to as a default area, but may not be limited thereto.

According to an example, the processor of the object recognition apparatus may assign different weights (e.g., weights in FIG. 2) for identifying an immobility score or a mobility score according to an area in which an object is included. This is because information of high importance may be changed depending on the position of an object. For example, the processor of the object recognition apparatus may set a weight of contour point distribution information (e.g., the contour point distribution information 225 in FIG. 2) to a value greater than 0 only in the second area 307. For example, the processor of the object recognition apparatus may set a weight of boundary object information (e.g., the boundary object information 227 in FIG. 2) in the first area 305 to be greater than a weight of the boundary object information in the second area 307 and a weight of the boundary object information in the third area 309.

FIG. 4 shows an example of a flowchart of operation of an object recognition apparatus for identifying whether an object is an object incapable of being in a moving state by identifying a contour-box distance in an object recognition apparatus or an object recognition method according to an example of the present disclosure.

Hereinafter, it is assumed that the object recognition apparatus 101 of FIG. 1 performs the process of FIG. 4. Additionally, in the description of FIG. 4, operations described as being performed by the apparatus may be understood as being controlled by the processor 105 of the object recognition apparatus 101.

Referring to FIG. 4, in a first operation 401, the processor of the object recognition apparatus according to an example may identify contour-box distances among the distances between a contour point and line segments constituting an object box.

To identify the contour-box distances, the processor of the object recognition apparatus may identify an object box including contour points that are obtained through a sensor (e.g., LIDAR sensor) and represent an object.

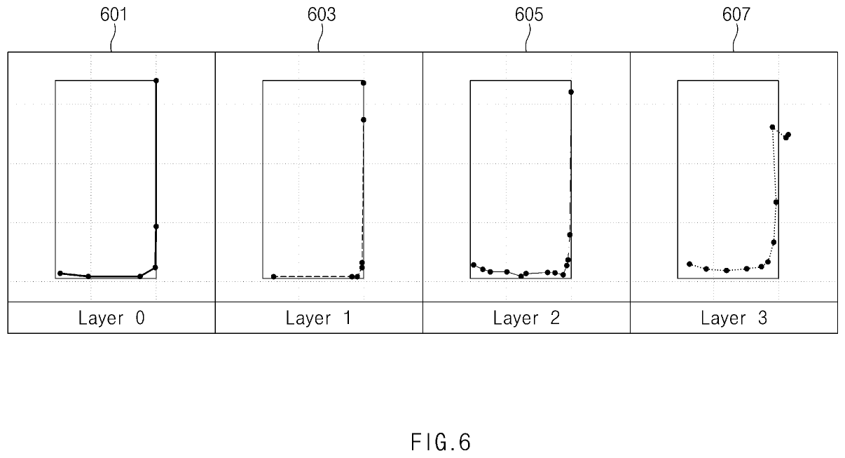

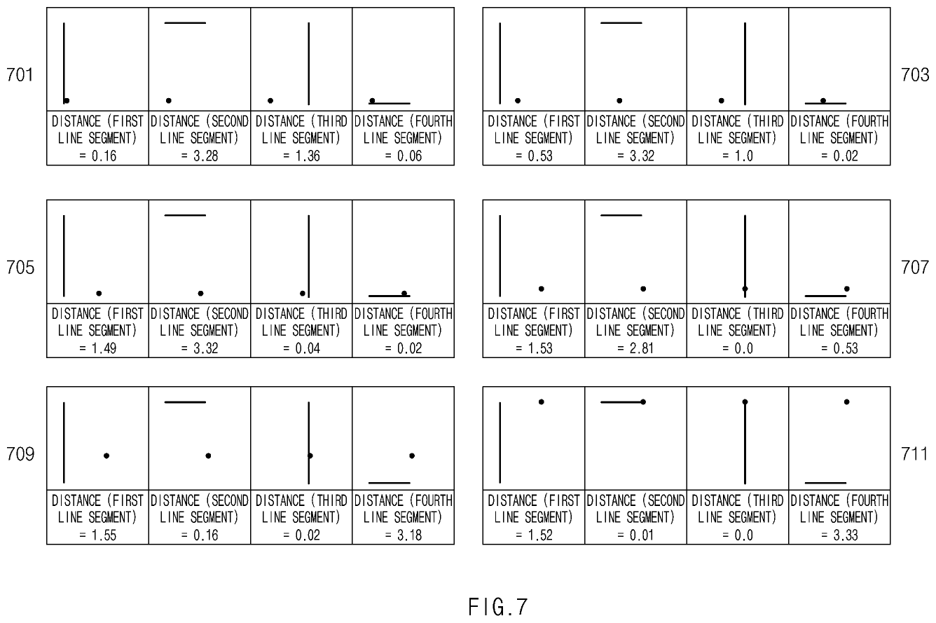

The processor of the object recognition apparatus may identify a contour-box distance, which is the minimum value among the distances between one of the contour points and the line segments constituting the object box. A method for identifying contour-box distances will be described below with reference to FIGS. 6 to 7.

In a second operation 403, the processor of the object recognition apparatus according to an example may identify whether there is a contour point in a layer, for which a contour-box distance is not identified. If there is a contour point in the layer, for which the contour-box distance is not identified, the processor of the object recognition apparatus may perform a first operation 401. If there is no contour point in the layer, for which the contour-box distance is not identified, the processor of the object recognition apparatus may identify a third operation 405.

According to an example, the processor of the object recognition apparatus may identify a contour-box distance for contour points included in one layer among a plurality of layers each including contour points.

In the third operation 405, the processor of the object recognition apparatus according to an example may identify whether there is a layer with a contour point for which the contour-box distance is not identified. If there is a layer with a contour point for which the contour-box distance is not identified, the processor of the object recognition apparatus may perform the first operation 401. If there is no layer with a contour point for which the contour-box distance is not identified, the processor of the object recognition apparatus may perform a fourth operation 407.

According to an example, the processor of the object recognition apparatus may identify the contour-box distance for contour points included in a layer other than a layer in which the contour-box distance is identified.

In the fourth operation 407, the processor of the object recognition apparatus according to an example may identify a degree of mismatch. The degree of mismatch may indicate the degree of mismatch between an object box and contour points, based on at least one of the contour-box distances of the contour points, or the number of contour points representing an object, or any combination thereof.

According to an example, the degree of mismatch may be identified based on the contour-box distances of all contour points representing the object.

For example, the degree of mismatch identified in a first method may be identified based on the sum of the contour-box distances from a first contour point to an M-th contour point (where M is a natural number of 2 or more). A specific layer may be composed of the first to M-th contour points.

The processor of the object recognition apparatus may identify the degree of mismatch based on a value obtained by dividing the sum of the contour-box distances of the contour points by the number of contour points representing the object.

For example, the degree of mismatch identified in a second method may be identified based on the sum of the distances of the last contour point among all contour points representing the object. In other words, the degree of mismatch identified in the second method may be identified based on the sum of the distances of the M-th contour point. The sum of the distances of the (N+1)-th contour point may represent a value obtained by adding the contour-box distance of the (N+1)-th contour point to the sum of the distances of the N-th contour point.

The processor of the object recognition apparatus may identify the degree of mismatch based on a value of obtained by dividing the sum of the distances of the M-th contour point by the number of contour points representing the object.

According to an example, the degree of mismatch may be identified based on the contour-box distances of contour points included in a plurality of layers.

For example, the degree of mismatch identified in a third method may be identified based on the sum of distances of the first layer to the M-th layer. The sum of distances of a specific layer may represent the sum of the contour-box distances of contour points included in the specific layer.

The processor of the object recognition apparatus may identify the degree of mismatch based on a value of obtained by dividing the sum of distances of the first layer to the M-th layer by the number of contour points representing the object.

For example, the degree of mismatch identified in a fourth method may be identified based on the sum of distances of the M-th layer.

The processor of the object recognition apparatus may identify the sum of distances of the N-th layer based on the sum of the contour-box distances of the contour points contained in an N-th layer (N is a natural number satisfying 1≤N≤M) among the first to M-th layers (where M is a natural number greater than or equal to 2) contained in an object box. The processor of the object recognition apparatus may identify the sum of distances of the (N+1)-th layer based on the sum of distances of the N-th layer and the sum of the contour-box distances of the contour points included in the (N+1)-th layer, which is the next layer after the N-th layer.

In a fifth operation 409, the processor of the object recognition apparatus according to an example may identify whether the object is an object incapable of being in a moving state based on the degree of mismatch.

According to an example, the processor of the object recognition apparatus may assign a specified value (e.g., 1) as a reliability indicating whether an object is an object incapable of being in a moving state based on identifying that the degree of mismatch is greater than a specified threshold degree of mismatch. The processor of the object recognition apparatus may identify whether the object is an object incapable of being in a moving state based on the reliability.

According to an example, the processor of the object recognition apparatus may assign a greater reliability value to an object as the degree of mismatch increases. In other words, the processor of the object recognition apparatus may identify a first reliability value as the reliability for indicating whether an object is an object incapable of being in a moving state based on identifying a first mismatch value as the degree of mismatch, and identify a second reliability value greater than the first reliability value as the reliability based on identifying a second mismatch value greater than the first mismatch value as the degree of mismatch. The processor of the object recognition apparatus may identify whether the object is an object incapable of being in a moving state based on the first reliability value or the second reliability value.

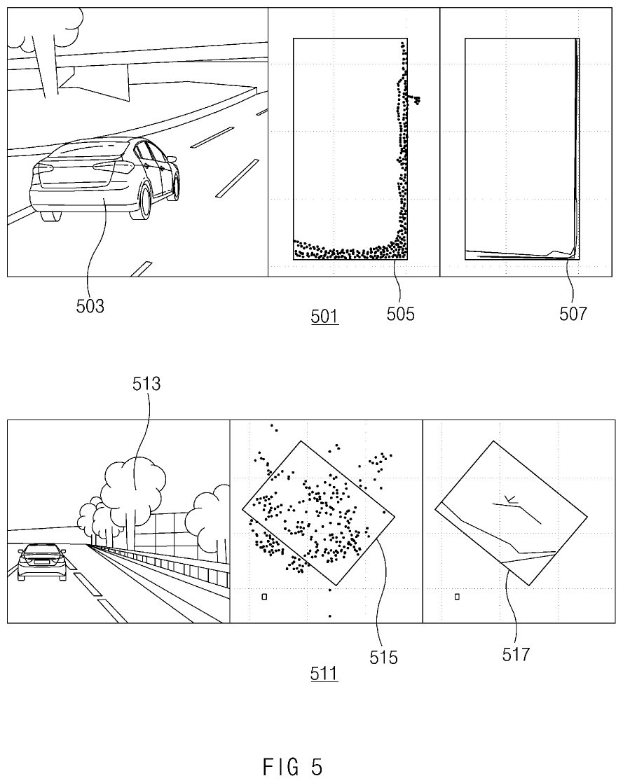

FIG. 5 shows an example of the distribution of contour points in an object recognition apparatus or an object recognition method according to an example of the present disclosure.

Referring to FIG. 5, in a first situation 501, the processor of an object recognition apparatus may obtain a cluster of points (e.g., a first point cloud 505) representing a first object 503. The processor of the object recognition apparatus may identify a first contour line 507 based on the first point cloud 505. The first contour line 507 may include a line connecting contour points identified based on the first point cloud 505.

In a second situation 511, the processor of the object recognition apparatus may obtain a second cluster of points (e.g., a second point cloud 515) representing a second object 513. The processor of the object recognition apparatus may identify a second contour line 517 based on the second point cloud 515. The second contour line 517 may include a line connecting contour points identified based on the second point cloud 515.

According to an example, the processor of the object recognition apparatus may identify the degree of mismatch of the first object 503 based on the distribution of contour points included in the first contour line 507.

The processor of the object recognition apparatus may identify a reliability value according to the box matching information (e.g., box matching information 215 in FIG. 2) of the first object 503 as being less than a reference value, based on the degree of mismatch of the first object 503. The processor of the object recognition apparatus may identify the first object 503 as a moving object (e.g., a moving vehicle) or as an object capable of being in a moving state (e.g., a parked vehicle) based on the reliability according to the box matching information of the first object 503.

According to an example, the processor of the object recognition apparatus may identify the degree of mismatch of the second object 513 based on the distribution of contour points included in the second contour line 517. The degree of mismatch of the first object 503 may be lower than that of the second object 513.

The processor of the object recognition apparatus may identify the reliability value according to the box matching information of the second object 513 as being greater than or equal to the reference value, based on the degree of mismatch of the second object 513. The processor of the object recognition apparatus may identify the second object 513 (e.g., a tree) as an object incapable of being in a moving state based on the reliability based on the box matching information of the second object 513.

In FIG. 5, the object box is shown as being rectangular, but examples of the present disclosure may not be limited thereto. According to an example, the object box may be composed of three or more line segments. For example, the object box may be in the shape of a triangle or a rectangle. For example, the object box may be in the shape of a pentagon, a hexagon, or an octagon.

Although it is shown in FIG. 5 that the object box identifies whether an object is an object (e.g., a tree, a road sign, a wall, a power line, etc) incapable of being in a moving state according to the degree of mismatch, examples of the present disclosure may not be limited thereto. According to an example, the processor of the object recognition apparatus may identify the object box as being a specified shape (e.g., a triangle, a rectangle, a pentagon, a hexagon, an octagon, a circle, an oval, a trapezoid, etc.) and identify a degree of mismatch, which indicates the degree of mismatch between the object box and the contour points based on at least one of the contour-box distances of contour points representing an object, or the number of the contour points representing the object, or any combination thereof. The processor of the object recognition apparatus may identify whether an object corresponds to a shape based on the degree of mismatch.

FIG. 6 shows an example of the distribution of contour points included in an individual layer for identifying a degree of match in an object recognition apparatus or an object recognition method according to an example of the present disclosure.

Referring to FIG. 6, a first set 601 may include contour points included in a first layer (e.g., layer 0). A second set 603 may include contour points included in a second layer (e.g., layer 1). A third set 605 may include contour points included in a third layer (e.g., layer 2). A fourth set 607 may include contour points included in a fourth layer (e.g., layer 3).

According to an example, the processor of the object recognition apparatus may identify a degree of mismatch based on the sum of the distances of each layer.

For example, the degree of mismatch identified by the third method (e.g., the third method given in the description of operation 407 of FIG. 4) may be identified based on the sum of the distances of the first layer to the M-th layer. The sum of distances of a specific layer may represent the sum of the contour-box distances of contour points included in the specific layer.

In other words, the sum of the distances of the first layer may include a value obtained by summing the contour-box distances of contour points included in the first layer. The sum of the distances of the second layer may include a value obtained by summing the contour-box distances of contour points included in the second layer. The processor of the object recognition apparatus may identify the degree of mismatch based on a value obtained by dividing a value, obtained by adding the sums of distances of the first layer to the M-th layer, by the number of contour points representing the object.

For example, the degree of mismatch identified by the fourth method (e.g., the fourth method given in the description of operation 407 of FIG. 4) may be identified based on the sum of the distances of the M-th layer that is the last layer.

In other words, the processor of the object recognition apparatus may identify the sum of distances of the N-th layer based on the sum of the contour-box distances of the contour points contained in an N-th layer (N is a natural number satisfying 1≤N≤M) among the first to M-th layers (where M is a natural number greater than or equal to 2) contained in an object box. The processor of the object recognition apparatus may identify the sum of distances of the (N+1)-th layer based on the sum of distances of the N-th layer and the sum of the contour-box distances of the contour points included in the (N+1)-th layer, which is the next layer after the N-th layer. The processor of the object recognition apparatus may identify the degree of mismatch based on a value of obtained by dividing the sum of the distances of the M-th layer by the number of contour points representing the object.

FIG. 7 shows an example of a contour-box distance corresponding to a contour point in an object recognition apparatus or an object recognition method according to an example of the present disclosure.

Referring to FIG. 7, in a first state 701, the processor of an object recognition apparatus may identify the contour-box distance of a first contour point. In a second state 703, the processor of the object recognition apparatus may identify the contour-box distance of a second contour point. In a third state 705, the processor of the object recognition apparatus may identify the contour-box distance of a third contour point. In a fourth state 707, the processor of the object recognition apparatus may identify the contour-box distance of a fourth contour point. In a fifth state 709, the processor of the object recognition apparatus may identify the contour-box distance of a fifth contour point. In the sixth state 711, the processor of the object recognition apparatus may identify the contour-box distance of a sixth contour point. The first contour point, the second contour point, the third contour point, the fourth contour point, the fifth contour point, and the sixth contour point may be included in a specific layer.

According to an example, to acquire a distance between one contour point (such as the first contour point, second contour point, third contour point, fourth contour point, fifth contour point, or sixth contour point) and one line segment of line segments (e.g., boundary lines) constituting an object box, the processor of the object recognition apparatus may identify a distance between the one contour point and the one line segment based on the coordinates of the contour point and the coordinates of two points that pass through the line segment. For example, if the coordinates of the one contour point are (y,x) and the coordinates of the two points passing through the one line segment are (y₁, x₁) and (y₂, x₂), the distance (d) between the one contour point and the one line segment may be identified according to Equation 1 below.

$$d = \frac{\vert ( {x}_{2} - {x}_{1} ) y + ( {y}_{1} - {y}_{2} ) x + ( {y}_{2} {x}_{1} - {y}_{1} {x}_{2} ) \vert}{\sqrt{{( {x}_{2} - {x}_{1} )}^{2} + {( {y}_{1} - {y}_{2} )}^{2}}} \qquad [ Equation 1 ]$$

According to an example, in the first state 701, the processor of the object recognition apparatus may identify the contour-box distance which is the minimum value among the distances between the first contour point and line segments constituting the object box. For example, the distances between the first contour point and the line segments constituting the object box may be 0.16 m, 3.28 m, 1.36 m, and 0.06 m, respectively. Among these, the minimum value of 0.06 m may be identified as the contour-box distance. Accordingly, the contour-box distance of the first contour point may be 0.06 m.

According to an example, in the second state 703, the distances between the second contour point and the line segments constituting the object box may be 0.53 m, 3.32 m, 1.0 m, and 0.02 m, respectively. Among these, the minimum value of 0.02 m may be identified as the contour-box distance. Accordingly, the contour-box distance of the second contour point may be 0.02 m.

According to one example, in the third state 705, the distances between the third contour point and the line segments constituting the object box may be 1.49 m, 3.32 m, 0.04 m, and 0.02 m, respectively. Among these, the minimum value of 0.02 m may be identified as the contour-box distance. Accordingly, the contour-box distance of the third contour point may be 0.02 m.

According to one example, in the fourth state 707, the distances between the fourth contour point and the line segments constituting the object box may be 1.53 m, 2.81 m, 0.0 m, and 0.53 m, respectively. Among these, the minimum value of 0.0 m may be identified as the contour-box distance. Accordingly, the contour-box distance of the fourth contour point may be 0.0 m.

According to an example, in the fourth state 709, the distances between the fourth contour point and the line segments constituting the object box may be 1.55 m, 0.16 m, 0.02 m, and 3.18 m, respectively. Among these, the minimum value of 0.02 m may be identified as the contour-box distance. Accordingly, the contour-box distance of the fifth contour point may be 0.02 m.

According to one example, in the sixth state 711, the distances between the sixth contour point and the line segments constituting the object box may be 1.52 m, 0.01 m, 0.0 m, and 3.33 m, respectively. Among these, the minimum value of 0.0 m may be identified as the contour-box distance. Accordingly, the contour-box distance of the sixth contour point may be 0.0 m.

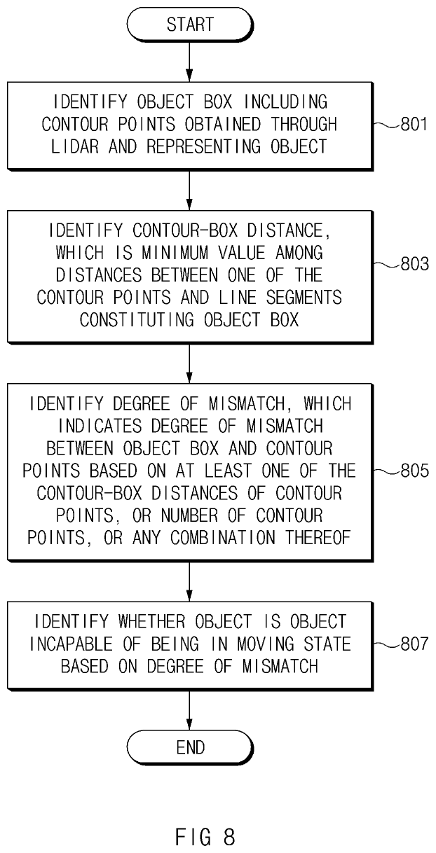

FIG. 8 shows an example of a flowchart of operation of an object recognition apparatus for identifying whether an object is an object incapable of being in a moving state according to a degree of mismatch in an object recognition apparatus or an object recognition method according to an example of the present disclosure.

Hereinafter, it is assumed that the object recognition apparatus 101 of FIG. 1 performs the process of FIG. 8. Additionally, in the description of FIG. 8, operations described as being performed by the apparatus may be understood as being controlled by the processor 105 of the object recognition apparatus 101.

Referring to FIG. 8, in a first operation 801, the processor of an object recognition apparatus according to an example may identify an object box including contour points which are obtained through a LIDAR and represent an object.

In a second operation 803, the processor of the object recognition apparatus according to an example may identify a contour-box distance, which is the minimum value among the distances between one of the contour points and the line segments constituting the object box.

In a third operation 805, the processor of the object recognition apparatus according to an example may identify a degree of mismatch, which indicates the degree of mismatch between the object box and the contour points based on at least one of the contour-box distances of contour points, or the number of the contour points, or any combination thereof. The number of contour points may denote the number of contour points representing an object.

In a fourth operation 807, the processor of the object recognition apparatus according to an example may identify whether the object is an object incapable of being in a moving state based on the degree of mismatch.

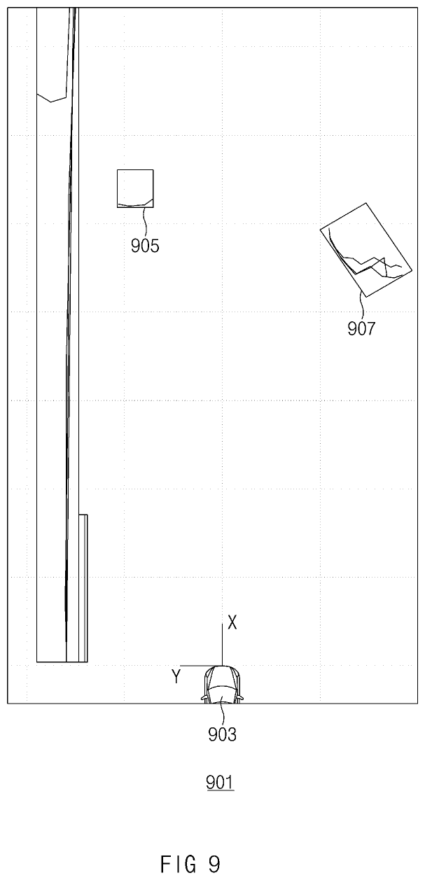

FIG. 9 shows an example of the distribution of contour points representing an object incapable of being in a moving state in an object recognition apparatus or an object recognition method according to an example of the present disclosure.

Referring to FIG. 9, in a first situation 901, an object recognition apparatus included in a host vehicle 903 may identify a first object 905 (e.g., a vehicle) and a second object 907 (e.g., a tree).

The first object 905 may correspond to a preceding vehicle of the host vehicle 903. The degree of mismatch of the first object 905 may be less than or equal to a threshold degree of mismatch. Accordingly, the first object 905 may be identified as a moving object or an object capable of being in a moving state.

The second object 907 may correspond to a bush in front of the host vehicle. The degree of mismatch of the second object 907 may be greater than the threshold degree of mismatch. Accordingly, the second object 907 may be identified as an object incapable of being in a moving state.

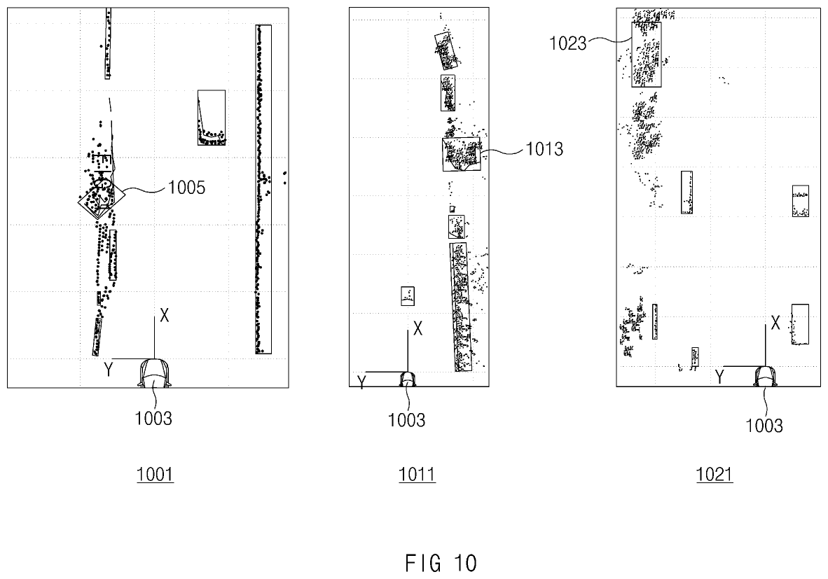

FIG. 10 shows an example of the distribution of contour points representing an object incapable of being in a moving state in an object recognition apparatus or an object recognition method according to an example of the present disclosure.

Referring to FIG. 10, in a first situation 1001, an object recognition apparatus included in a host vehicle 1003 may identify a first object 1005 (e.g., a power line). In a second situation 1011, the object recognition apparatus included in the host vehicle 1003 may identify a second object 1013 (e.g., a road sign). In a third situation 1021, the object recognition apparatus included in the host vehicle 1003 may identify a third object 1023.

According to an example, the first object 1005 may correspond to a plant in a flower bed located next to a road on which the host vehicle 1003 is traveling. The degree of mismatch of the first object 1005 may be greater than a specified threshold degree of mismatch. Accordingly, the first object 1005 may be identified as an object incapable of being in a moving state.

According to one example, the second object 1013 may correspond to a bush located next to a road on which the host vehicle 1003 is traveling. The degree of mismatch of the second object 1013 may be greater than the specified threshold degree of mismatch. Accordingly, the second object 1013 may be identified as an object incapable of being in a moving state.

According to an example, the third object 1023 may correspond to a tree located next to the road on which the host vehicle 1003 is traveling. The degree of mismatch of the third object 1023 may be greater than the specified threshold degree of mismatch Accordingly, the third object 1023 (e.g., a tree) may be identified as an object incapable of being in a moving state.

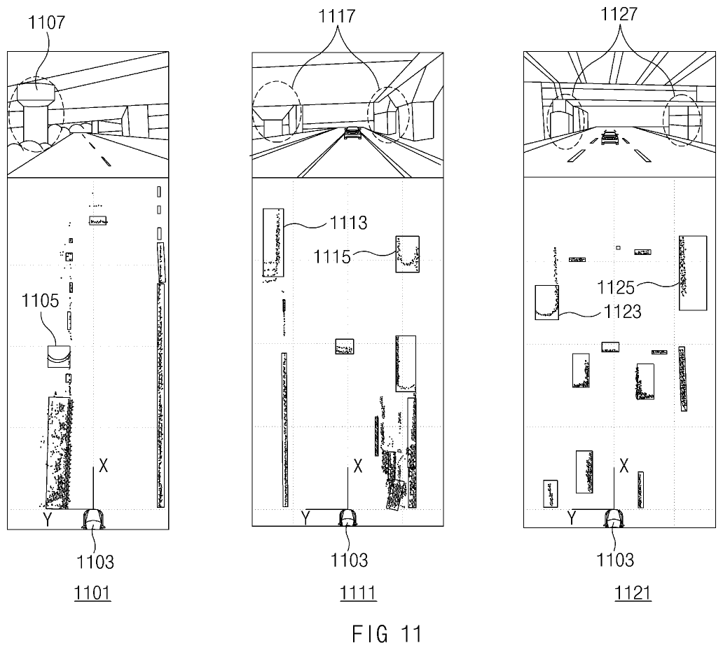

FIG. 11 shows an example of the distribution of contour points representing an object incapable of being in a moving state in an object recognition apparatus or an object recognition method according to an example of the present disclosure.

Referring to FIG. 11, in a first situation 1101, an object recognition apparatus included in a host vehicle 1103 according to an example may identify a first object 1105 (e.g., a first pillar of a first bridge). In a second situation 1111, the object recognition apparatus included in the host vehicle 1103 may identify a second object 1113 (e.g., a first pillar of a second bridge) and a third object 1115 (e.g., a second pillar of the second bridge). In the third situation 1121, the object recognition apparatus included in the host vehicle 1103 may identify a fourth object 1123 and a fifth object 1125.

According to an example, in the first situation 1101, the first object 1105 may correspond to a pillar 1107 of a first bridge pier located next to a road on which the host vehicle 1103 is traveling. The degree of mismatch of the first object 1105 may be greater than a specified threshold degree of mismatch. Accordingly, the first object 1105 may be identified as an object incapable of being in a moving state.

According to an example, in a second situation 1111, the second object 1113 and the third object 1115 may correspond to a pillar 1117 of a second bridge pier located next to the road on which the host vehicle 1103 is traveling. The degree of mismatch of the second object 1113 and the degree of mismatch of the third object 1115 may be greater than a specified threshold degree of mismatch. Accordingly, the second object 1113 and the third object 1115 may be identified as objects incapable of being in a moving state.

According to an example, in a third situation 1121, the fourth object 1123 and the fifth object 1125 may correspond to a pillar 1127 of a third bridge pier located next to the road on which the host vehicle 1103 is traveling. The degree of mismatch of the fourth object 1123 and the degree of mismatch of the fifth object 1125 may be greater than the specified threshold degree of mismatch. Accordingly, the fourth object 1123 and the fifth object 1125 may be identified as objects incapable of being in a moving state.

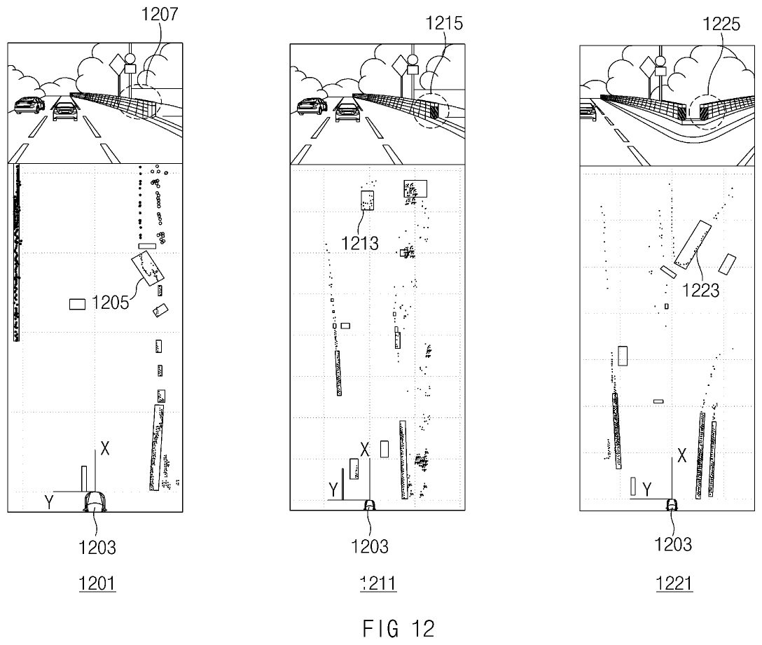

FIG. 12 shows an example of the distribution of contour points representing an object incapable of being in a moving state in an object recognition apparatus or an object recognition method according to an example of the present disclosure.

Referring to FIG. 12, in a first situation 1201, an object recognition apparatus included in a host vehicle 1203 according to an example may identify a first object 1205 (e.g., a temporary guardrail). In a second situation 1211, the object recognition apparatus included in the host vehicle 1203 may identify a second object 1213 (e.g., a first shock absorber). In a third situation 1221, the object recognition apparatus included in the host vehicle 1203 may identify a third object 1223 (a second shock absorber).

According to an example, in the first situation 1201, the first object 1205 may correspond to a temporary guardrail 1207 located next to a road on which the host vehicle 1203 is traveling. The degree of mismatch of the first object 1205 may be greater than a specified threshold degree of mismatch. Accordingly, the first object 1205 may be identified as an object incapable of being in a moving state.

According to an example, in the second situation 1211, the second object 1213 may correspond to a shock absorber 1215 of a highway located next to the road on which the host vehicle 1203 is traveling. The degree of mismatch of the second object 1213 may be greater than a specified threshold degree of mismatch. Accordingly, the second object 1213 may be identified as an object incapable of being in a moving state.

According to an example, in the third situation 1221, the third object 1223 may correspond to a shock absorber 1225 of a highway located next to the road on which the host vehicle 1203 is traveling. The degree of mismatch of the third object 1223 may be greater than the specified threshold degree of mismatch Accordingly, the third object 1223 may be identified as an object incapable of being in a moving state.

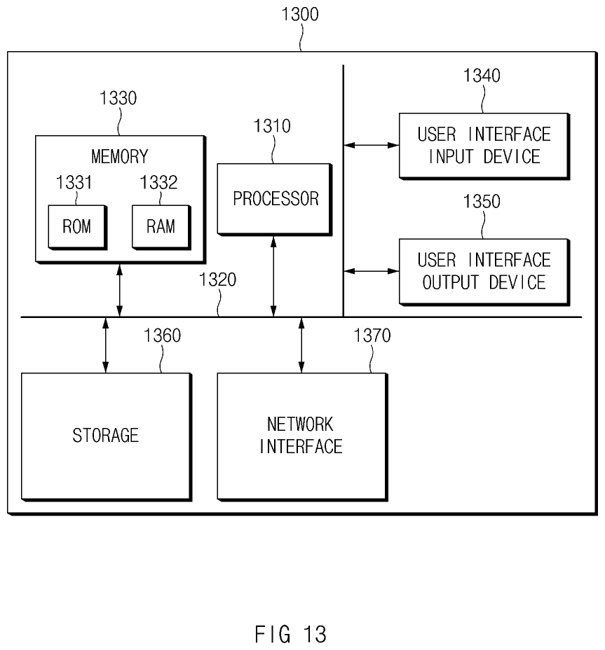

FIG. 13 shows an example of a computing system related to an object recognition apparatus or an object recognition method according to an example of the present disclosure.

Referring to FIG. 13, a computing system 1300 may include at least one processor 1310, a memory 1330, a user interface input device 1340, a user interface output device 1350, storage 1360, and a network interface 1370, which are connected with each other via a bus 1320.

The processor 1310 may be a central processing unit (CPU) or a semiconductor device that processes instructions stored in the memory 1330 and/or the storage 1360. The memory 1330 and the storage 1360 may include various types of volatile or non-volatile storage media. For example, the memory 1330 may include a ROM (Read Only Memory) 1331 and a RAM (Random Access Memory) 1332.

Thus, the operations of the method or the algorithm described in connection with the examples disclosed herein may be embodied directly in hardware or a software module executed by the processor 1310, or in a combination thereof. The software module may reside on a storage medium (that is, the memory 1330 and/or the storage 1360) such as a RAM, a flash memory, a ROM, an EPROM, an EEPROM, a register, a hard disk, a removable disk, and a CD-ROM.

The example storage medium may be coupled to the processor 1310, and the processor 1310 may read information out of the storage medium and may record information in the storage medium. Alternatively, the storage medium may be integrated with the processor 1310. The processor and the storage medium may reside in an application specific integrated circuit (ASIC). The ASIC may reside within a user terminal. In another case, the processor and the storage medium may reside in the user terminal as separate components.

The present disclosure has been made to solve the above-mentioned problems occurring in the prior art while advantages achieved by the prior art are maintained intact.

An example of the present disclosure provides an object recognition apparatus and method for identifying whether an object is an object incapable of being in a moving state.

An example of the present disclosure provides an object recognition apparatus and method for identifying whether an object is an object incapable of being in a moving state according to the degree of mismatch identified based on contour points and an object box.

An example of the present disclosure provides an object recognition apparatus and method for improving the accuracy of determination of identifying whether an object is an object incapable of being in a moving state.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, an object recognition apparatus includes a LIDAR and a processor.

According to an example, the processor may identify an object box obtained through the LIDAR and including contour points representing an object, identify a contour-box distance, which is a minimum value among distances between one of the contour points and line segments constituting the object box, identify a degree of mismatch indicating a degree of mismatch between the object box and the contour points based on at least one of the contour-box distances of the contour points, or a number of contour points representing the object, or any combination thereof, and identify whether the object is an object incapable of being in a moving state based on the degree of mismatch.

According to an example, the processor may identify a sum of distances of an N-th contour point based on the contour-box distance of the N-th contour point (N is a natural number satisfying 1≤N≤M) among first to M-th contour points (where M is a natural number of 2 or more) representing the object, identify a sum of distances of an (N+1)-th contour point based on the sum of distances of the N-th contour point and a contour-box distance of the (N+1)-th contour point that is a next contour point of the N-th contour point, and identify the degree of mismatch based on a sum of distances of an M-th contour point.

According to an example, the processor may identify the contour-box distance of an N-th contour point (N is a natural number satisfying 1≤N≤M) among first to M-th contour points (where M is a natural number of 2 or more) representing the object, and identify the degree of mismatch based on a sum of the contour-box distances of the first contour point to the M-th contour point.

According to an example, the processor may identify a sum of distances of an N-th layer based on a sum of contour-box distances of contour points included in the N-th layer (N is a natural number satisfying 1≤N≤M) among first to M-th layers (where M is a natural number greater than or equal to 2) included in the object box, identify a sum of distances of an (N+1)-th layer based on a sum of distances of the N-th layer and a sum of the contour-box distances of the contour points included in the (N+1)-th layer, which is the next layer after the N-th layer, and identify the degree of mismatch based on the sum of the contour-box distances of the first contour point to the M-th contour point.

According to an example, the processor may identify a sum of distances of an N-th layer based on a sum of contour-box distances of contour points included in the N-th layer (N is a natural number satisfying 1≤N≤M) among first to M-th layers (where M is a natural number greater than or equal to 2) included in the object box, and identify the degree of mismatch based on a value obtained by summing up the sums of distances of the first layer to the M-th layer and a number of contour points representing the object.

According to an example, the processor may identify a distance between one contour point and one line segment based on coordinates of the one contour point and coordinates of two points passing through the one line segment among line segments constituting the object box.

According to an example, the processor may identify the degree of mismatch based on a value obtained by dividing a sum of the contour-box distances of the contour points by a number of contour points representing the object.

According to an example, the processor may identify the object box made of three or more line segments.

According to an example, the processor may assign a specified value as a reliability for indicating whether the object is an object incapable of being in a moving state based on identifying that the degree of mismatch is greater than a specified threshold degree of mismatch, and identify whether the object is an object incapable of being in a moving state based on the reliability.

According to an example, the processor may identify a first reliability value as a reliability for indicating whether the object is an object incapable of being in a moving state based on identifying a first degree of mismatch as the degree of mismatch, identify a second reliability value greater than the first reliability value as the reliability based on identifying a second degree of mismatch greater than the first degree of mismatch as the degree of mismatch, and identify whether the object is an object incapable of being in a moving state based on the first reliability value or the second reliability value.

According to an example, the processor may identify the object box as being a specified shape, identify a degree of mismatch indicating a degree of mismatch between the object box and the contour points, based on at least one of the contour-box distances of the contour points, or a number of the contour points representing the object, or any combination thereof, and identify whether the object is an object corresponding to the shape based on the degree of mismatch.

According to an example, the processor may assign, to the object, an identifier indicating that the object is an object incapable of being in a moving state, based on identifying that the object is an object incapable of being in a moving state.

According to an example, the processor may identify a reliability indicating whether the object is an object incapable of being in a moving state based on the degree of mismatch, and identify whether the object is an object incapable of being in a moving state based on a value obtained by multiplying the reliability by a weight.

According to an example of the present disclosure, an object recognition method includes identifying an object box obtained through a LIDAR and including contour points representing an object, identifying a contour-box distance, which is a minimum value among distances between one of the contour points and line segments constituting the object box, identifying a degree of mismatch indicating a degree of mismatch between the object box and the contour points based on at least one of the contour-box distances of the contour points, or a number of contour points representing the object, or any combination thereof, and identifying whether the object is an object incapable of being in a moving state based on the degree of mismatch.

According to an example, the identifying of the degree of mismatch indicating the degree of mismatch between the object box and the contour points based on at least one of the contour-box distances of the contour points, or the number of contour points representing the object, or any combination thereof may include identifying a sum of distances of an N-th contour point based on the contour-box distance of the N-th contour point (N is a natural number satisfying 1≤N≤M) among first to M-th contour points (where M is a natural number of 2 or more) representing the object, identifying a sum of distances of an (N+1)-th contour point based on the sum of distances of the N-th contour point and a contour-box distance of the (N+1)-th contour point that is a next contour point of the N-th contour point, and identifying the degree of mismatch based on a sum of distances of an M-th contour point.

According to an example, the identifying of the degree of mismatch indicating the degree of mismatch between the object box and the contour points based on at least one of the contour-box distances of the contour points, or the number of contour points representing the object, or any combination thereof may include identifying the contour-box distance of an N-th contour point (N is a natural number satisfying 1≤N≤M) among first to M-th contour points (where M is a natural number of 2 or more) representing the object, and identifying the degree of mismatch based on a sum of the contour-box distances of the first contour point to the M-th contour point.

According to an example, the identifying of the degree of mismatch indicating the degree of mismatch between the object box and the contour points based on at least one of the contour-box distances of the contour points, or the number of contour points representing the object, or any combination thereof may include identifying a sum of distances of an N-th layer based on a sum of contour-box distances of contour points included in the N-th layer (N is a natural number satisfying 1≤N≤M) among first to M-th layers (where M is a natural number greater than or equal to 2) included in the object box, identifying a sum of distances of an (N+1)-th layer based on a sum of distances of the N-th layer and a sum of the contour-box distances of the contour points included in the (N+1)-th layer, which is the next layer after the N-th layer, and identifying the degree of mismatch based on the sum of distances of the M-th layer and a number of contour points representing the object.

According to an example, the identifying of the degree of mismatch indicating the degree of mismatch between the object box and the contour points based on at least one of the contour-box distances of the contour points, or the number of contour points representing the object, or any combination thereof may include identifying a sum of distances of an N-th layer based on a sum of contour-box distances of contour points included in the N-th layer (N is a natural number satisfying 1≤N≤M) among first to M-th layers (where M is a natural number greater than or equal to 2) included in the object box, and identifying the degree of mismatch based on a value obtained by summing up the sums of distances of the first layer to the M-th layer and a number of contour points representing the object.

According to an example, the identifying of the contour-box distance, which is the minimum value among distances between one of the contour points and line segments constituting the object box may include identifying a distance between one contour point and one line segment based on coordinates of the one contour point and coordinates of two points passing through the one line segment among line segments constituting the object box.

According to an example, the identifying of the degree of mismatch indicating the degree of mismatch between the object box and the contour points based on at least one of the contour-box distances of the contour points, or the number of contour points representing the object, or any combination thereof may include identifying the degree of mismatch based on a value obtained by dividing a sum of the contour-box distances of the contour points by a number of contour points representing the object.

The above description is merely illustrative of the technical idea of the present disclosure, and various modifications and variations may be made without departing from the essential characteristics of the present disclosure by those skilled in the art to which the present disclosure pertains.

Accordingly, the example disclosed in the present disclosure is not intended to limit the technical idea of the present disclosure but to describe the present disclosure, and the scope of the technical idea of the present disclosure is not limited by the example. The scope of protection of the present disclosure should be interpreted by the following claims, and all technical ideas within the scope equivalent thereto should be construed as being included in the scope of the present disclosure.

The present technology may increase the accuracy of determination of identifying whether an object is an object incapable of being in a moving state based on the degree of mismatch.

Further, the present technology may identify whether an object is an object incapable of being in a moving state based on the distribution of contour points, by identifying whether the distribution of the contour points matches an object box.

Further, the present technology may enhance user experience by improving the accuracy of determination of identifying whether an object is an object incapable of being in a moving state.

Further, the present technology may improve the performance of autonomous driving or driver assistance driving by improving the accuracy of determination of identifying whether an object is an object incapable of being in a moving state.

In addition, various effects may be provided that are directly or indirectly understood through the disclosure.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus comprising:
a sensor; and
a processor,
wherein the processor is configured to:
identify, based on sensing information of the sensor, an object box comprising a plurality of contour points representing an object;
determine a plurality of minimum values, wherein each of the plurality of minimum values is a minimum value among distances between one of the plurality of contour points and line segments constituting a boundary of the object box;
determine a degree of mismatch between the object box and the plurality of contour points based on at least one of:
the plurality of minimum values, or
a number of the plurality of contour points; and
output, based on the degree of mismatch, a signal indicating whether the object is a stationary object.

2. The apparatus of claim 1, wherein the processor is configured to:
determine a sum of distances between an N-th contour point and the line segments based on a minimum value among distances between the N-th contour point and the line segments, wherein the N-th contour point is among a first contour point to M-th contour point representing the object, and wherein N is a natural number satisfying 1≤N≤M and M is a natural number of 2 or greater;
determine a second sum of distances between an (N+1)-th contour point and the line segments based on the sum of distances and a minimum value among distances between the (N+1)-th contour point and the line segments, wherein the (N+1)-th contour point is next to the N-th contour point; and
determine, based on a sum of distances between an M-th contour point and the line segments, the degree of mismatch.

3. The apparatus of claim 1, wherein the processor is configured to:
determine a minimum value among distances between an N-th contour point and the line segments, wherein N is a natural number satisfying 1≤N≤M and the N-th contour points is among a first contour point to M-th contour point representing the object, wherein M is a natural number of 2 or greater; and
determine the degree of mismatch based on a sum of the plurality of minimum values, wherein each of the plurality of minimum values is a minimum value among distances between a respective contour point among the first contour point to the M-th contour point of the plurality of contour points and the line segments.

4. The apparatus of claim 1, wherein the processor is configured to:
determine a sum of distances associated with an N-th layer based on a sum of minimum values among distances between contour points included in the N-th layer and the line segments, wherein N is a natural number satisfying 1≤N≤M and the N-th layer is among first to M-th layers included in the object box, and wherein M is a natural number greater than or equal to 2;
determine a sum of distances associated with an (N+1)-th layer based on the sum of distances associated with the N-th layer and a sum of minimum values among distances between contour points included in the (N+1)-th layer and the line segments, wherein the (N+1)-th layer is next to the N-th layer; and
determine the degree of mismatch based on a sum of distances associated with the M-th layer and a number of the plurality of contour points representing the object.

5. The apparatus of claim 1, wherein the processor is configured to:
determine a sum of distances associated with an N-th layer based on a sum of a set of minimum values, wherein each of the set of minimum values is a minimum value among distances between one of contour points included in the N-th layer and the line segments, wherein N is a natural number satisfying 1≤N≤M and the N-th layer is among a first layer to M-th layer included in the object box, and wherein M is a natural number greater than or equal to 2; and
determine the degree of mismatch based on a value obtained by summing up distances associated with the first layer to the M-th layer and a number of the plurality of contour points representing the object.

6. The apparatus of claim 1, wherein the processor is configured to determine a distance between one contour point of the plurality of contour points and one line segment of the line segments based on coordinates of the one contour point and coordinates of two points passing through the one line segment.

7. The apparatus of claim 1, wherein the processor is configured to determine the degree of mismatch based on a value obtained by dividing a sum of the plurality of minimum values by a number of the plurality of contour points representing the object.

8. The apparatus of claim 1, wherein the object box comprises three or more line segments.

9. The apparatus of claim 1, wherein the processor is configured to:
assign a reliability value for indicating whether the object is a stationary object based on determining that the degree of mismatch is greater than a threshold degree of mismatch; and
determine, based on the reliability value, whether the object is the stationary object.

10. The apparatus of claim 1, wherein the processor is configured to:
determine a first reliability value for indicating whether the object is a stationary object based on determining a first degree of mismatch as the degree of mismatch;
determine a second reliability value greater than the first reliability value based on determining a second degree of mismatch greater than the first degree of mismatch as the degree of mismatch; and
determine whether the object is a stationary object based on the first reliability value or the second reliability value.

11. The apparatus of claim 1, wherein the processor is configured to:
identify the object box as being a specified shape; and
determine, based on the degree of mismatch, whether the object is an object corresponding to the specified shape.

12. The apparatus of claim 1, wherein the processor is configured to assign, to the object, an identifier indicating that the object is a stationary object, based on a determination that the object is a stationary object.

13. The apparatus of claim 1, wherein the processor is configured to:
determine, based on the degree of mismatch, a reliability value indicating whether the object is a stationary object; and
determine whether the object is a stationary based on a value obtained by multiplying the reliability value by a weight.

14. A method comprising:
identifying, based on sensing information of the sensor, an object box comprising a plurality of contour points representing an object;
determining a plurality of minimum values, wherein each of the plurality of minimum values is a minimum value among distances between one of the plurality of contour points and line segments constituting a boundary of the object box;
determining a degree of mismatch between the object box and the plurality of contour points based on at least one of:
the plurality of minimum values, or
a number of the plurality of contour points; and
outputting, based on the degree of mismatch, a signal indicating whether the object is a stationary object.

15. The method of claim 14, wherein the determining the degree of mismatch comprises:
determining a sum of distances between an N-th contour point and the line segments based on a minimum value among distances between the N-th contour point and the line segments, wherein N is a natural number satisfying 1≤N≤M and the N-th contour point is among a first contour point to M-th contour point representing the object, and wherein M is a natural number of 2 or greater;
determining a second sum of distances between an (N+1)-th contour point and the line segments based on the sum of distances and a minimum value among distances between the (N+1)-th contour point and the line segments, wherein the (N+1)-th contour point is next to the N-th contour point; and
determining, based on a sum of distances between an M-th contour point and the line segments, the degree of mismatch.

16. The method of claim 14, wherein the determining the degree of mismatch comprises:
determining a minimum value among distances between an N-th contour point and the line segments, wherein N is a natural number satisfying 1≤N≤M and the N-th contour point is among a first contour point to M-th contour point representing the object, wherein M is a natural number of 2 or greater; and
determining the degree of mismatch based on a sum of the plurality of minimum values, wherein each of the plurality of minimum values is a minimum value among distances between a respective contour point among the first contour point to the M-th contour point of the plurality of contour points and the line segments.

17. The method of claim 14, wherein the determining the degree of mismatch comprises:
determining a sum of distances associated with an N-th layer based on a sum of a set of minimum values, wherein each of the set of minimum values is a minimum value among distances between one of contour points included in the N-th layer and the line segments, wherein N is a natural number satisfying 1≤N≤M and the N-th layer is among a first layer to M-th layer included in the object box, and wherein where M is a natural number greater than or equal to 2;
determining a sum of distances associated with an (N+1)-th layer based on the sum of distances associated the N-th layer and a sum of a second set of minimum values, wherein each of the second set of minimum values is a minimum value among distances between one of contour points included in the (N+1)-th layer and the line segments, wherein the (N+1)-th layer is next to the N-th layer; and
determining the degree of mismatch based on a sum of distances associated with the M-th layer and a number of the plurality of contour points representing the object.

18. The method of claim 14, wherein the determining the degree of mismatch comprises:
determining a sum of distances associated with an N-th layer based on a sum of a set of minimum values, wherein each of the set of minimum values is a minimum value among distances between one of contour points included in the N-th layer and the line segments, wherein N is a natural number satisfying 1≤N≤M and the N-th layer is among a first layer to M-th layer included in the object box, wherein M is a natural number greater than or equal to 2; and
determining the degree of mismatch based on a value obtained by summing up distances associated with the first layer to the M-th layer and a number of the plurality of contour points representing the object.

19. The method of claim 14, wherein the determining the plurality of minimum values comprises determining a distance between one contour point of the plurality of contour points and one line segment of the line segments based on coordinates of the one contour point and coordinates of two points passing through the one line segment.

20. The method of claim 14, wherein the determining the degree of mismatch comprises determining the degree of mismatch based on a value obtained by dividing a sum of the plurality of minimum values by a number of contour points representing the object.
